(19) United States
(12) Patent Application Publication
(10) Pub. No.: US 2009/0134577 A1
(43) Pub. Date: May 28, 2009

(54) CASINO CARD GAME

(76) Inventor: RONALD PERRY FINNERMAN, Calabasas, CA (US)

Correspondence Address: MICHAEL BLAINE BROOKS, P.C., P.O. BOX 1630, SIMI VALLEY, CA, 93062-1630, US

(21) Appl. No.: 12/099,399

(22) Filed: Apr. 8, 2008

Related U.S. Application Data
(60) Provisional application No. 61/004,489, filed on Nov. 27, 2007.
(60) Provisional application No. 61/009,582, filed on Dec. 31, 2007.
(60) Provisional application No. 61/063,102, filed on Feb. 1, 2008.

(51) Int. Cl. A63F 1/00; G06F 17/00

(52) U.S. Cl. 273/292; 273/274; 463/13

(57) ABSTRACT

Methods, devices and systems of play for a casino card game having 5-card poker resolution using community cards and a house's hand filled according to Blackjack/21 rules.

### CROSS-REFERENCE TO RELATED APPLICATIONS

This application claims the benefit of U.S. Provisional Patent Application No. 61/004,489 filed Nov. 27, 2007; U.S. Provisional Patent Application No. 61/009,582 filed Dec. 31, 2007, and U.S. Provisional Patent Application No. 61/063,102 filed Feb. 1, 2008; the contents of all of which, including all appendices, are hereby incorporated by reference herein for all purposes.

### FIELD OF ENDEAVOR

The present invention, in its several embodiments, relates to methods, devices and systems for casino gaming, and more particularly to methods, devices and systems of play for a casino card game.

### BACKGROUND

Blackjack is a game with a 52 card deck where each player gets two cards. Card valuation is based on the face identity or value of the cards, such as: ace, two, three, four, five, six, seven, eight, nine, ten, and three kinds of face cards valued at ten, i.e., jack, queen, and king. At the option of the holder of the hand, the ace may be valued at eleven or one. When an ace is combined with other cards, the summed value is termed a “soft” value when ace is valued at eleven and a “hard” value when the ace is valued at one. The dealer makes no decision, but to follow hand-fill rules and will hit, i.e., get another card when his or her hand is lower than 17. Once it is 17 or better or 21, the dealer freezes his hand. The object of the game is for the dealer to have the best hand and not get over 21. Aces count as 11 or one. Face cards count as 10. Texas Hold'em is a game of poker where the players each get two cards, and they play against each other and use five community cards to come up with the best five card hand out of the 7 cards. Hand rankings are: 1. Straight Flush; 2. Four of a Kind; 3. Full House; 4. Flush; 5. Straight; 6. three of a kind; 7. two pair; 8. one pair 9. highest cards. As card games, these games may be played in a casino where a dealer plays for the house and these games may be embodied in machines and systems.

### SUMMARY

The present invention may be embodied in examples, such as a method of playing a card game, a machine-enabled method of play, and/or a device that may be used by a player. For example, a method of playing a card game by a dealer and a player, the game may include steps, not necessarily in the following order, of: (a) a dealer accepting the player's first wager; (b) a dealer dealing two cards to the player; (c) a dealer dealing two cards to himself or herself, i.e., to the dealer playing the house's hand; (d) the dealer accepting the player's second wager indicating the player's hand will be resolved against the dealer's hand under five-card poker rules after three or more community cards are dealt face-up, wherein the first wager and second wager comprise the player's total wager; (e) the dealer dealing three or more community cards face-up; (f) the dealer dealing cards to the dealer's hand according to Blackjack counting rules for filling the dealer's hand with the caveat that this step may require no cards being dealt to the dealer as explained in the detailed description; (g) the dealer configuring a first highest ranking five-card hand from a combination of the dealer's hand and the dealt community cards; (h) the dealer configuring a second highest ranking five-card hand from a combination of the player's hand and the dealt community cards; and (i) if the configured player's hand ranks higher than the configured dealer's hand based on five-card poker rules, then the dealer paying the player based on the player's total wager. The method of card play may have the step of dealing two cards to the dealer comprising the dealer dealing one card face-up and on card face-down to the dealer and, if so, the method of card play may also include, after the step of accepting the player's second wager, the step of the dealer turning the card dealt face-down of dealer's hand face-up.

An exemplary machine-enabled method of playing the card game of the present invention may include having three or more community cards themselves being described as having states, e.g., the queen of hearts is a state of the 52 states possible in a standard poker deck of cards, and the exemplary machine-enabled method may include a plurality of cards comprising a card hand of a player wherein each card of the card hand of the player has a state, and the exemplary machine-enabled method may include a plurality of cards that include a card hand of a house or dealer wherein each card of the card hand of the house has a state, and the exemplary machine-enabled game may include the steps, not necessarily in the following order, of: (a) providing a machine configured to receive player input via a user interface and output, via the user interface: the state of each house's card, the state of each player's card, the state of the three or more community cards, and a play resolution result; (b) accepting, as a machine input via the user interface, a player's first wager; (c) generating a state for each of two player cards; (d) outputting, as a machine output via the user interface, the state of the two generated player cards; (e) generating a state for each of a first house card and a second house card; (f) outputting, as a machine output via the user interface, the state of the first generated house card; (g) accepting, as a machine input via the user interface, the player's second wager, wherein the first wager and second wager comprise the player's total wager; (h) generating a state for each of three or more community cards; (i) outputting, as a machine output via the user interface, the states of each of the three or more generated community cards; (j) outputting, as a machine output via the user interface, the state of the second generated house card; and (k) filling, according to Blackjack counting rules for filling the house's hand, by generating a state for each of zero or more additional cards for the house's hand in that the Blackjack filling rules may preclude any additional cards be applied to the house's hand; (l) outputting, as a machine output via the user interface the states of each of the zero or more generated additional cards of the house's hand; (m) if the player's second wager was accepted, then resolving comprising: (1) configuring a first highest ranking five-card hand as the final house's hand from a combination of states of the cards of the filled house's hand and the states of the community cards; (2) configuring a second highest ranking five-card hand as the final player's hand from a combination of states of the cards of the player's hand and the states of the community cards; and (3) testing if the states of the card combination of the final player's hand rank higher based on five-card poker rules than the states of the card combination of the final house's hand, and then generating a payout based on the player's total wager, and outputting, via the user interface, the play resolution result comprising the payout.

An exemplary gaming device for playing a card game includes a central processing unit (CPU) in communication with accessible memory and a user interface via a data bus wherein the CPU is configured to execute the steps of: (a) accepting a player's first wager; (b) generating a state for each of two player cards; (c) outputting the state of the two generated player cards; (d) generating a state for each of a first house card and a second house card; (e) outputting the state of the first generated house card; (f) accepting the player's second wager, wherein the first wager and second wager comprise the player's total wager; (g) generating a state for each of three or more community cards; (h) outputting the states of each of the three or more generated community cards; (i) outputting the state of the second generated house card; and (j) filling, according to Blackjack counting rules for filling the house's hand, by generating a state for each of zero or more additional cards for the house's hand; (k) outputting the states of each of the zero or more generated additional cards of the house's hand; (l) if the player's second wager was accepted, then resolving comprising: (1) configuring a first highest ranking five-card hand as the final house's hand from a combination of states of the cards of the filled house's hand and the states of the community cards; (2) configuring a second highest ranking five-card hand as the final player's hand from a combination of states of the cards of the player's hand and the states of the community cards; and (3) testing if the card state combination of the final player's hand ranks higher based on five-card poker rules than the cards state combination of the final house's hand, and then generating a payout based on the player's total wager and outputting a play resolution result comprising the payout.

### BRIEF DESCRIPTION OF THE DRAWINGS

Embodiments of the present invention are illustrated by way of example and not limitation in the figures of the accompanying drawings, and in which:

FIG. 1 is a graphical depiction of an exemplary card table top in top plan view for several embodiments of the present invention;

FIGS. 2A and 2B are top level flowcharts of an exemplary method embodiment of the present invention;

FIGS. 3A and 3B are top level flowcharts of another exemplary method embodiment of the present invention;

FIG. 4 is a top level functional block diagram of an exemplary host computer for machine-enabled embodiments of the present invention;

FIG. 5 is a top level functional block diagram of an exemplary client-server network for machine-enabled several embodiments of the present invention;

FIG. 6 is an exemplary graphic user interface (GUI) for machine-enabled embodiments of the present invention that include a touch-screen display; and

FIGS. 7A and 7B are top level flowcharts of another exemplary method embodiment of the present invention.

### DETAILED DESCRIPTION

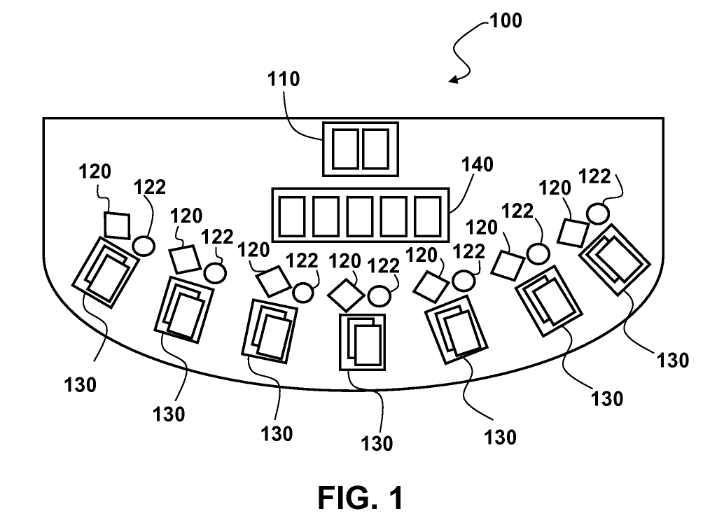

FIG. 1 illustrates in a top plan view an exemplary card table top 100 that may be used in a multiple player embodiment of the present invention. Playing for the house is a dealer who may have a card region 110 or two card regions disposed proximate to the dealer, one region, or sub-region, for a card dealt face-down and another region or sub-region, for a card dealt face-up. Individual players make take positions across the card table top 100 from the dealer. A player's station may have wager regions 120, 122 disposed proximate to the player, e.g., a first region for a first wager 122 or ante wager and a second region reserved for a second wager 120 other than a double-down wager. A player's card region 130 may be interposed between the wager regions 120, 122 and the player where the card region 130 may be reserved for two cards, each dealt face-down, for the player. In the mid region of the card table top 100, a general card region 140 and/or an array of five card regions may be disposed and reserved for five community cards each dealt face-up.

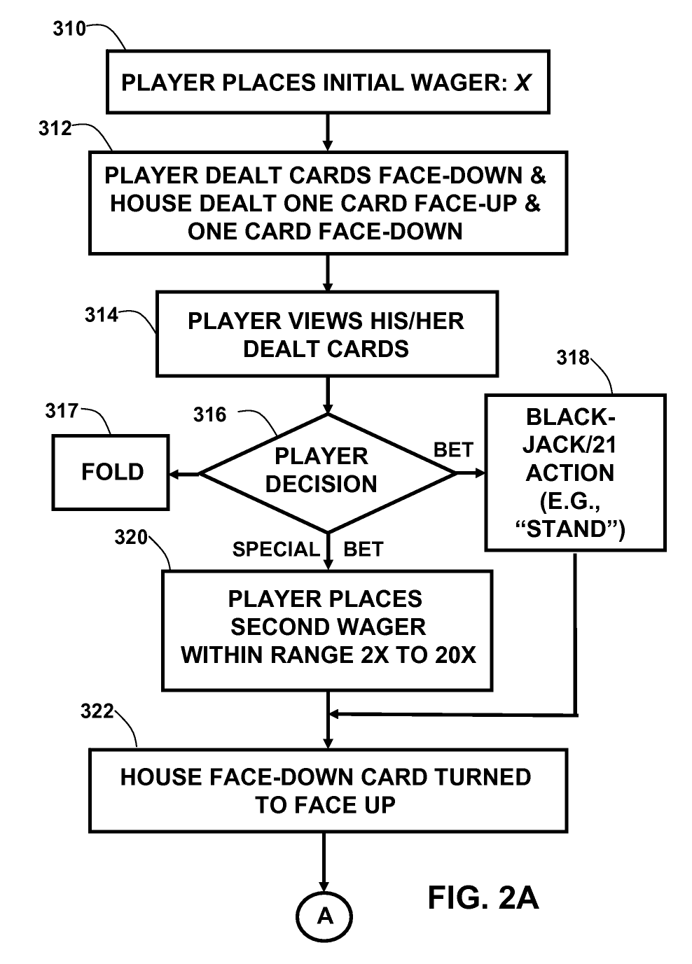

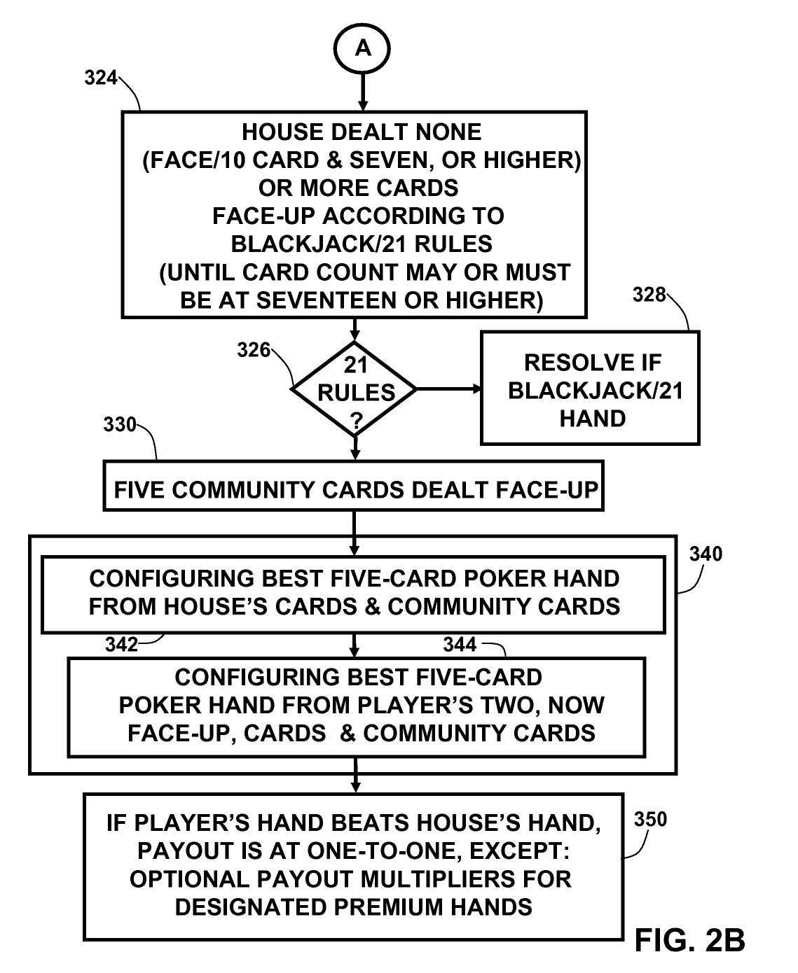

FIGS. 2A and 2B are exemplary top level flowcharts of a card game play embodiment of the present invention involving a single player and the house as may be represented by a dealer player on behalf of the house. For multiplayer embodiments, actions of the players may be effected, i.e., initiated by the dealer, according to relative seating position of each player at the table. Returning to the exemplary flowchart of FIG. 2A of a hand, the player places an initial wager, x (step 210). The dealer may deal cards from a single shuffled deck of 52 standard playing cards having a pattern back side and a face side having surface indicia of one of four suits, e.g., hearts, diamonds, clubs and spades, where the surface indicia for each particular suit is also indicative of a face identity or value such as: ace, two, three, four, five, six, seven, eight, nine, ten, and three kinds of face cards valued at ten, i.e., jack, queen, and king. At the option of the holder of the hand, the ace may be valued at eleven or one. When an ace is combined with other cards, the summed value is termed a “soft” value when ace is valued at eleven and a “hard” value when the ace is valued at one. The dealer may first deal the player a first card face-down and the dealer may deal the house a card face-down and the dealer may next deal the player a second card face-down and the dealer may deal the house a card face-up (step 212). The player is given an opportunity to view his or her cards (step 214). The player is given the opportunity (decision step 216) to fold (step 217), or to continue the card game according to standard Blackjack/21 rules for example by placing a second wager that may then make available to the player subsequent Blackjack/21 actions (step 218), i.e., requesting a card, standing and receiving no more cards, permissibly splitting the hand into two hands with a matching bet and addressing the matter of additional cards for the two hands, or declaring a double down and receiving just one more card dealt face-up. Otherwise, the player may indicate his or her decision to not continue according to the standard Blackjack/21 rules (decision step 216) by, for example, placing a second wager in the second wager table region in amount double (2×) the first wager up to a table limit (step 220), e.g., twenty times (20×) the first wager. Once the continued game play for the player has been indicated to the dealer by the player's action, the dealer may turn the house card that was dealt face-down over so that both house face cards are face-up (step 222). The dealer may then deal the house's hand according to standard Blackjack/21 rules (step 224) where the dealer must stop dealing to the house's hand once the sum of the house's face-up cards equals seventeen or higher. Referring back to step 218, if the player had designated Blackjack/21 rules (test step 226), then the player's cards may be turned face-up and the dealer may then collect the wager or resolve the payout (step 228), if any, to the player according to standard Blackjack/21 rules. If no other player designated, the 7 card play, i.e., the alternative play to the standard Blackjack/21 play, then after the dealer has resolved all outstanding player Blackjack/21 hands, and after the dealer collects the dealt cards, then the dealer may call for a new hand to accept new first wagers.

Again referring back to the action steps 218 and 220 evidencing each players' decision (step 216) as to direction of play, if, instead of designating his or her hand to be played according to standard Blackjack/21 rules (step 218), the player had designated the alternative to the standard Blackjack/21 (step 220), or if another player playing at the same table, had designated the alternative to the standard Blackjack/21, then, after the hands of those players having designated Blackjack/21 play are resolved (step 228), the dealer may exit the Blackjack/21 stage of play by dealing five community cards face-up (step 230). Those players having their hands resolved at the close of the Blackjack stage of play must wait until the dealer collects all the cards and calls for a new first wager in order to resume play. With the five community cards placed face up on the card table, resolution of winning hands (step 240) may commence where the house's hand may be configured (step 242) to yield the highest standard five-card poker hand based on five cards selected from a cumulative set of cards comprising the community cards and the set of cards dealt the house during the Blackjack/21 stage of play. In order to resolve the remaining players' hands at the table (step 244), if the player had designated the alternative to the standard Blackjack/21 (step 220), then the player's hand may be configured to yield the highest standard five-card poker hand based on five cards selected from a cumulative set of cards comprising the community cards and the set of two cards dealt the player at the beginning of the Blackjack/21 stage of play now turned face-up. If a player has a winning configured five-card poker hand, then his or her winning is equal to the wager, i.e., the value corresponding to, one-to-one (step 250), the value waged by the player in the range of 2× to 20×. Embodiments of the present card game invention may include a premium schedule. For example, a full house may payout as two-to-one and a four-of-a-kind may payout at eight-to-one. For embodiments where optional premium payouts are not available for particular best winning hands, the hand may be reconfigured so that the hand remains a winning hand while also allowing the player of the reconfigured hand to receive a payout premium.

One may note that since the dealer is unable to act on the knowledge of the player's two face down cards, in a single player game, the player's cards may be dealt face-up. But, where more than a single player in engaged in the exemplary table game of FIGS. 2A and 2B, the collective information of a player's cards dealt face up may disadvantage the house and so it may be preferred the dealer become habituated to dealing to players the first and second cards as face-down even when a single player is at the table.

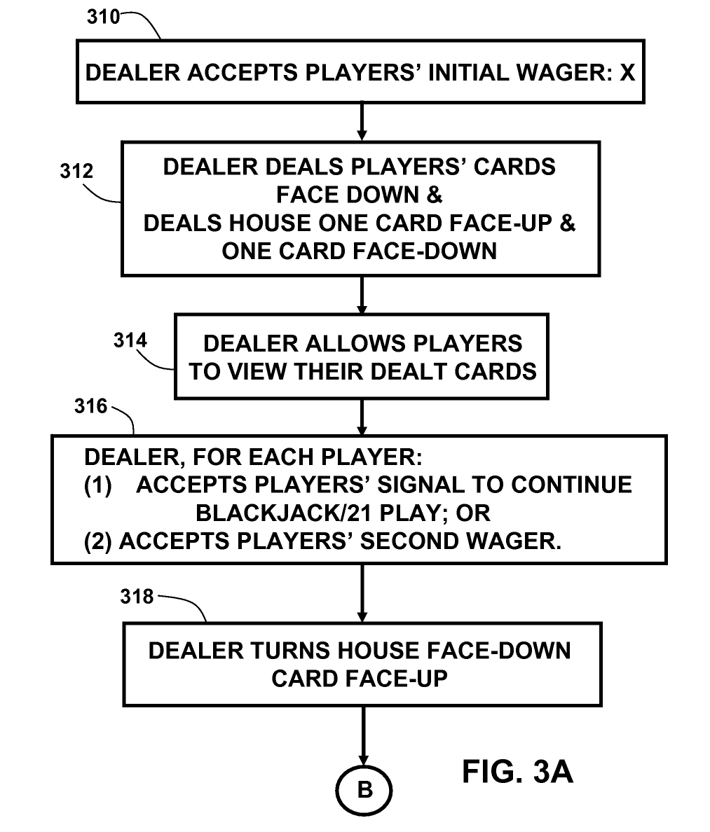

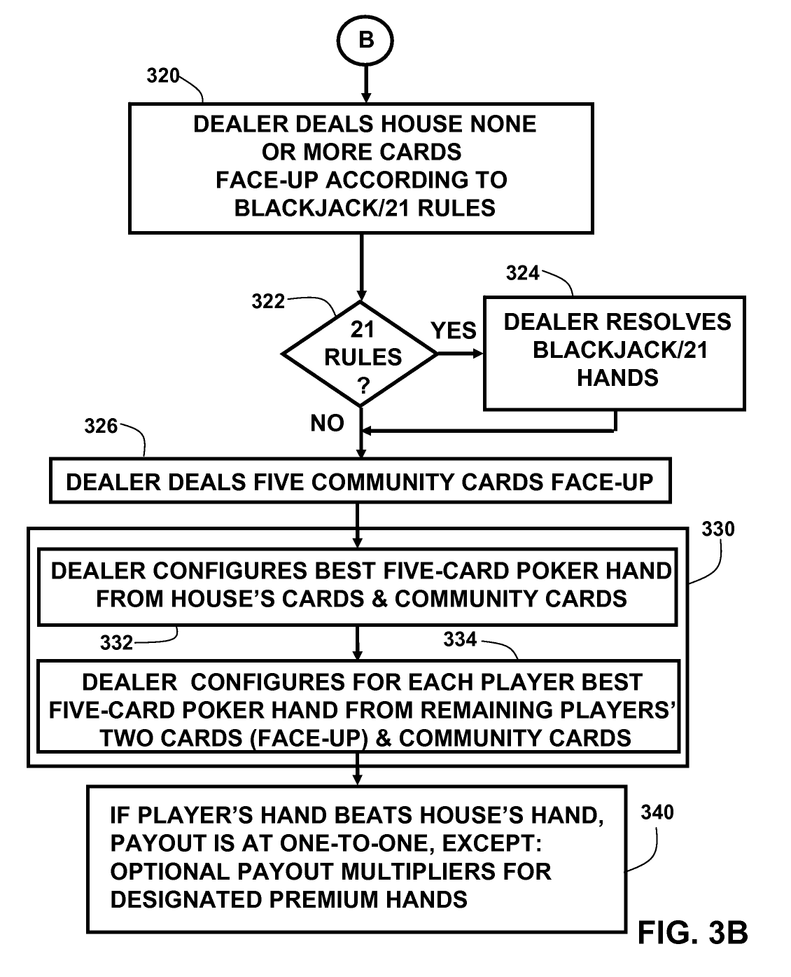

FIGS. 3A and 3B are exemplary top level flowcharts of a card game play embodiment of the present invention as exemplary instructions for execution by a dealer. To join each player to the hand that is about to commence, the dealer may indicate that he or she has accepted each player's initial wager, x (step 310). The dealer may then deal a single card face-down to each joined player and to the house's hand being played by the dealer and the dealer may then deal a single card face-down to each of the players and a card face-up to the house's hand (step 312). The dealer allows each player a turn to view their dealt cards (step 314) and then may accept each player's individual signal to either continue with Blackjack/21 play or their respective second wager indicating to engage in an alternative to the Blackjack/21 play (step 316). Once the dealer has accepted signal or indication for each player's selected path of play, the dealer may turn the house's face-down card face-up (step 318). The dealer may then deal no or one or more cards to the house's hand according to Blackjack/21 rules for filling a dealer's hand (step 320). For example, if one of the two cards of the house's hand is a ten or a face card and the combined value of the two cards is seventeen or more, the dealer does not deal the house's hand a third card. If one of the two cards is an ace, i.e., a soft eleven or less, and the combined value of the two cards is seventeen or less, then the dealer deals one or more cards to the house's hand until a “hard” value of seventeen or higher is achieved. Referring back to the kind of play accepted by the dealer at step 316, if Blackjack/21 play was accepted (test step 322), then the dealer may resolve all hands designated as Blackjack/21 hands according to standard Blackjack payout rules (step 324). For example, if the house's hand is valued at a “hard” twenty-two, the Blackjack/21 players having a hand card value twenty-one or less will receive a one-to-one payout. Once all hands designated as Blackjack/21 hands are resolved, play continues for the remaining player when the dealer deals face-up five community cards (step 326). Steps of resolving the 7-cards pay portion 330 may include the dealer configuring the best five-card poker hand from the house's hand (step 332) to yield the highest standard five-card poker hand based on five cards selected from a cumulative set of cards comprising the community cards and the set of cards dealt the house during the Blackjack/21 stage of play. The dealer may then request each player that designated the alternative, i.e., 7-card, path of play may then turn-over their respective two face-down cards. The dealer configures, or acknowledges the player-proposed configuration of, the best five-card poker hand for each of the remaining players' to yield the highest standard five-card poker hand based on five cards selected from a cumulative set of cards comprising the community cards and the set of two cards dealt the respective player during the Blackjack/21 stage of play (step 334) now turned face-up. The dealer determines whether each remaining player has a winning configured five-card poker hand (step 340), and if so, pays out to such player his or her respective winning in an amount equal to the wager, i.e., the value corresponding to, one-to-one, the value waged by the player in the range of 2× to 20×. Embodiments of the present card game invention may include the dealer applying a premium schedule. For example, a full house may be paid out by the dealer at two-to-one and a four-of-a-kind may be paid out by the dealer payout at eight-to-one. For embodiments where optional premium payouts are not available for particular best winning hands, the dealer may reconfigure the respective player's so that the respective player's hand both remains a winning hand while also allowing the respective player to receive a payout premium.

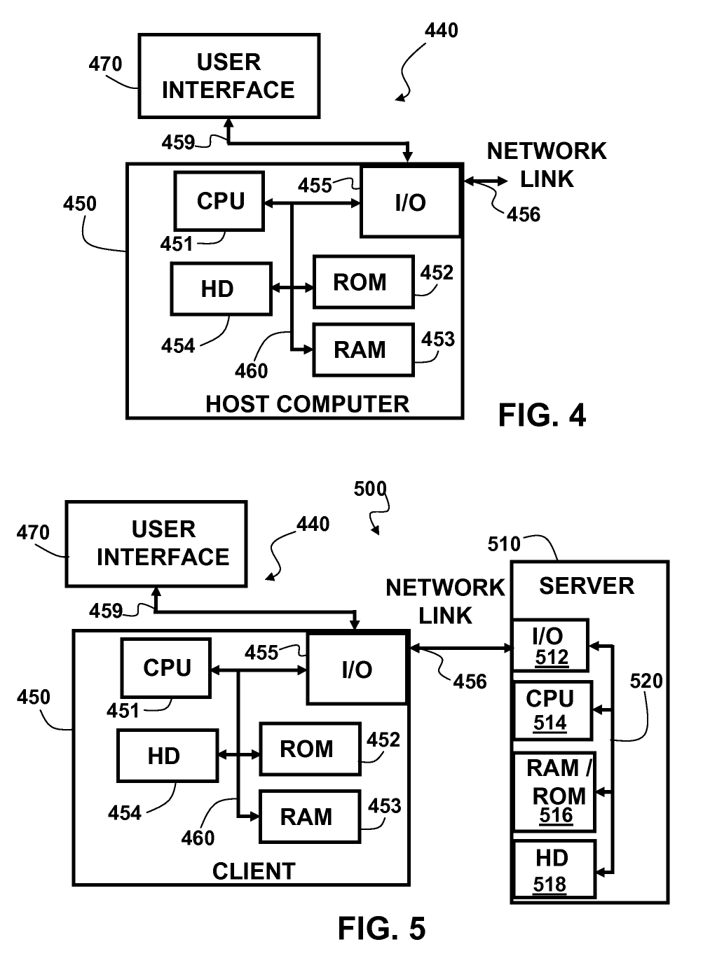

FIG. 4 illustrates a top level functional block diagram of a host computer station 440 that may be configured to execute the steps of the several embodiments of the present invention. In this example, a host computer 450 is shown having a central processing unit (CPU) 451, accessible memory that includes read-only memory (ROM) 452, random access memory (RAM) 453 and a mass storage unit shown as a hard disk drive (HD) 454, and an input/output module 455 where these exemplary elements may be in communication with one another via a data bus 460. A user interface 470 may be in communication with the host computer 450 via a link 459 that may be, for example, a wireless link or a universal serial bus (USB). The user interface may include tactile input such as a keyboard and/or mouse or a touch-screen. The user interface may include a display, such as a liquid-crystal (LCD) display and the host computer operating system may support a display which may include a graphic user interface (GUI) operative with a touch screen. The exemplary host computer station may include a network link 456 that may be wireless or a cable, such as an Ethernet™ cable that may communicate to other processing devices and may provide access to the internet or a local area network.

FIG. 5 illustrates a top level functional block diagram of a computing system 500 that includes a host computer station 440 processing as a client that is in communication via a network link 456 to another processing device 510 processing as a server. The exemplary server is shown to include a sever input/output module 512, a server CPU 514, server RAM/ROM 516, and server mass storage (server HD) 518 where these exemplary elements may be in communication with one another via a server data bus 520.

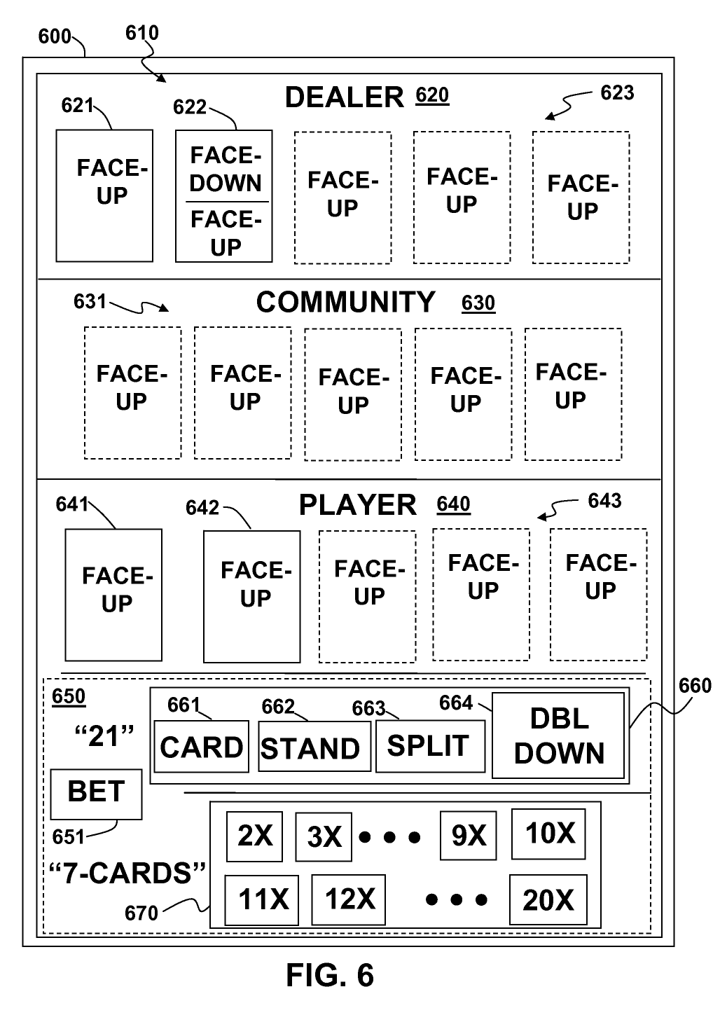

FIG. 6 is an exemplary display 600 of the examples of host computer system embodiments 450 of FIGS. 4 and 5, i.e., an exemplary machine embodiment, which may include a touch-screen 610 as part of the user interface 470 (FIGS. 4 and 5). Other embodiments may have the tactile input being a panel of buttons or a keyboard or the tactile input is supplemented or replaced by microphone-derived oral input from the user. Alternative or complementary output may include auditory states of the face-up cards and wager states provided to the user via any combination of speaker, headphone or ear bud devices. The upper-level field of the touch-screen 610 of FIG. 6 is illustrated in this example as a DEALER field 620 having regions apportioned for the display of a face-up card 621 and a face-down card 622. Additional field space 623 of the DEALER field may be allocated in the event the additional face-up cards for the house or dealer's hand may be required during the Blackjack/21 stage of play. A mid-level field is illustrated in this example as a COMMUNITY field 630 having regions allocated 631 for the display of five face-up cards that may follow the Blackjack/21 state of play. The lower-level field is illustrated in this example as a PLAYER field 640 having regions allocated for the display of two face-up cards 641, 642 and additional field space 643 of the PLAYER field may be allocated in the event additional face-up cards for the player may be required in the event the player elects to continue with and remain within the Blackjack/21 stage of play. Also shown in the PLAYER field 640 is a sub-field 650 allocated to display touch-screen buttons to initiate the hand, e.g., tapping the screen at “BET” 651, to allow the player to put up the first wager or ante. Once the DEALER field 620 displays the house's face-up card 621 and face-down card 622 and the PLAYER field displays the two face-up cards 641, 642, the player elects to either: (1) continue with and remain within the Blackjack/21 stage of play, i.e., “21,” e.g., by tapping “BET” 651 again which may double the ante and make available a Blackjack/21 array 660 that may comprise: a “CARD” touch-sensitive region or screen button 661, a “STAND” touch-sensitive region or screen button 662, “SPLIT” touch-sensitive region or screen button 663, or a “DBL DOWN” (double down) touch-sensitive region or screen button 664; or (2) move to the alternative stage of play, i.e., “7-CARDS,” e.g., by tapping one of the bet multipliers shown by example in a bet multiplier array 670 of touch-sensitive regions or screen buttons as “2×” through “10×” display elements or touch-screen buttons and “11×” though “20×” display elements or touch-screen buttons. For bet multipliers higher than a certain amount, for example higher than 5×, the touch-screen may display a confirmation button displaying the tapped bet multiplier value where the displayed element requires a tap to proceed and may also display a revise button requiring a tap to return the display of the lower field to the bet multiplier array having the displayed elements.

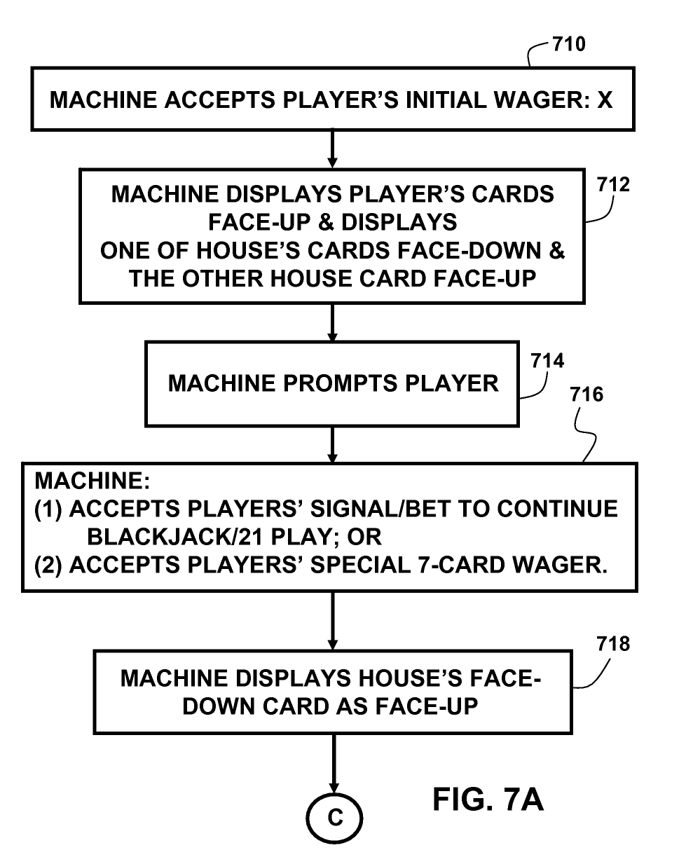

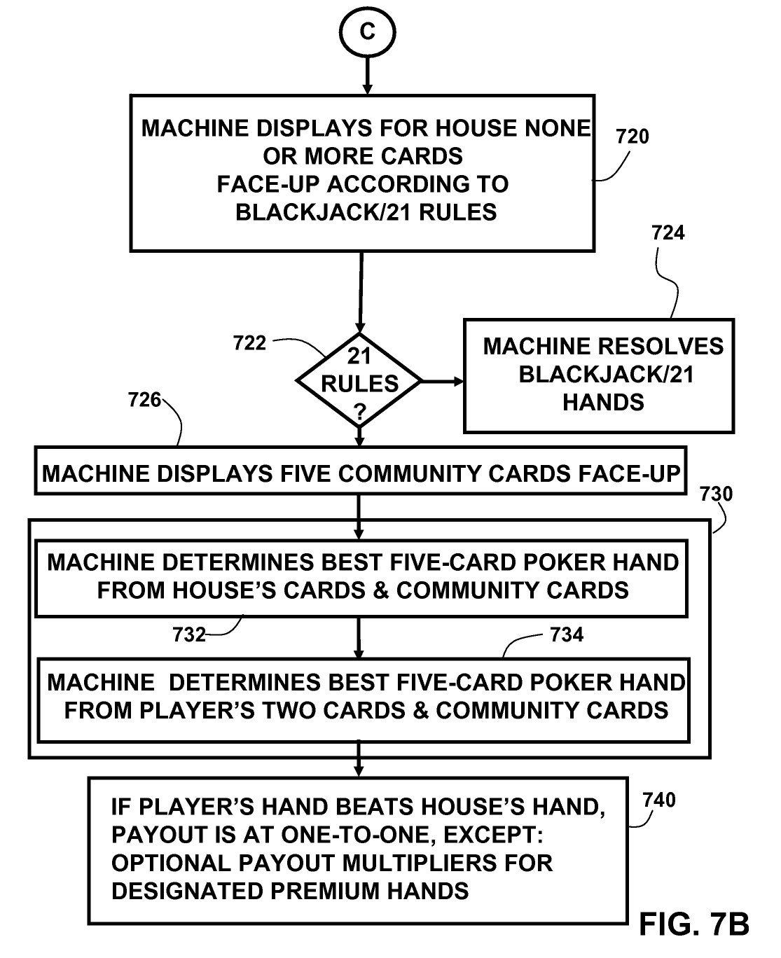

FIGS. 7A and 7B are exemplary top level flowcharts of a card game play embodiment of the present invention as exemplary instruction for a machine-enabled process. Exemplary machines and systems that may enable the process include those illustrated by FIGS. 4 and 5 and others such as hand-held devices including gaming units and cell phones as stand alone devices or as nodes within a system, and home and arcade game stations as stand alone devices or as nodes within a system. In those jurisdictions where actual money transfer would be violative of wagering laws, such embodiments may apply fictive currency or other means of representing the player's standing relative to the house and/or past performances via a memory store and such devices are accordingly entertainment devices. An exemplary machine-enabled process of FIGS. 7A and 7B may include the accepting (step 710), by the machine, of a player's initial wager, x. The machine may display the players two cards face-up and one of the house's two initial cards face-up and another of the house's initial cards face-down (step 712). The machine may then prompt the player (step 714) for example by displaying two or more touch-screen button in halos or if a panel of lighted buttons, illuminating two or more buttons or cause the button illumination to blink. The machine may then accepts (step 716) the player's input which may be limited to directing the machine to either to continue and remain within the Blackjack/21 play or, with the minimal doubling of a bet indicative of other than doubling down, move the play beyond the standard Blackjack/21 play to the 7-card play.

Returning to FIG. 6, if the player had tapped a button indicating or selecting Blackjack/21 play, then additional cards may be displayed in the PLAYER field face-up and one at a time an in response to the tap of the “CARD” button 661 or once in response to the tap of the “DBL DOWN” button 664 along with a display that the wager was doubled while remaining in the Blackjack/21 stage of play. If the player, after designating continued Blackjack/21 play taps the “SPLIT” button 663, then the PLAYER field 640 may reconfigure to display two hands and a halo or some other graphic designation may be used to indicate the hand to which the “CARD” button 661 and/or “STAND” button buttons will apply if tapped. The player's turn ends (per hand if split) when either the “STAND” button 662 is tapped or if the hard card value exceeds twenty-one. Returning to FIGS. 7A and 7B, the machine may then display the house face-down card as face-up (step 718). The machine may then display for the house additional cards according to the compulsory card-drawing rules of Blackjack/21 for the dealer's or house's hand (step 720). For example, if the house's hand is a “ten” of face card and a “seven” of higher up to an ace, the machine would not draw and display additional cards for the house's hand, i.e., no additional card states generated and/or displayed. If the two displayed cards are an ace and a “six” or lower, then the house will receive and display a third and subsequent cards i.e., one or more card states generated and/or displayed, until the three or more cards have a hard card value of greater than twenty-one or a soft card value of greater than seventeen. If the machine at step 716 had accepted the player's indication for Blackjack/21 play (test step 722), the machine may then resolve (step 724) the house's hand relative to the player's hand (or hands if split) under standard Blackjack/21 rules for best hand, and a winner may be displayed and if the player is the winner, the machine may also display the winning payout amount. Returning to FIG. 6 to illustrate the display of step 720 of FIG. 7B, if the house's hard card value does not exceed twenty-one, then the DEALER field may then display additional face-up cards if the initial hard card value is less than seventeen and thereafter until the three or more cards have a hard card value of greater than twenty-one or a soft card value of greater than seventeen.

If the machine at step 716 of FIG. 7A had accepted the player's indication for “7-CARDS” play, i.e., the player indicated a rejection of continued Blackjack/21 play (test step 722), then the machine may display five community cards. Returning again to FIG. 6, if the player, rather than tapping a button selecting Blackjack/21 play, instead taps a button within bet multiplier array of “7-CARDS” play, e.g., one of the “2×” though “20×” buttons, then, before or after the house has drawn its cards according to Blackjack/21 play, the COMMUNITY field will display five face-up cards 726 and the DEALER field may display additional face-up cards if the initial hard card value is less than seventeen and thereafter until the three or more cards have a hard card value of greater than twenty-one or a soft card value of greater than seventeen. Steps of resolving the 7-cards pay portion (730 of FIG. 7B) may include the best five card poker hand configured by the machine from the cards comprising those displayed in the DEALER field and the five display in the COMMUNITY field for the house/machine (step 732 of FIG. 7B) and comparing the configured house hand with the best five card poker hand configured by the machine from the cards comprising the two displayed in the PLAYER field the and five displayed in the COMMUNITY filed for the player (step 734). The winner may be displayed, the cards selected for the configured hands may be designated by hallows or by some other designation such as by dimming the unselected cards. In addition, if the winner is the player, the payout may also be displayed, that is, the screen may display an amount equal to the wager, i.e., the value corresponding to, one-to-one, the value waged by the player in the range of 2× to 20× (step 740 of FIG. 7B). The machine may execute other embodiments of the present card game invention that may include the dealer applying a premium schedule. For example, a full house may be paid out by the dealer at two-to-one and a four-of-a-kind may be paid out by the dealer payout at eight-to-one. For embodiments where optional premium payouts are not available for particular best winning hands, the machine may reconfigure and display or indicate the player reconfigured hand that remains a winning hand while also allowing the respective player to receive a payout premium. The premium schedules may be displayed in one of the fields if a “7-CARD” related button is tapped, or placed in a field throughout play or displayed as a separate screen display.

One of ordinary skill in the art will also appreciate that the modules and functions described herein may be further subdivided, combined, and/or varied and yet still be in the spirit of the embodiments of the invention. In addition, while a number of variations of the invention have been shown and described in detail, other modifications, which are within the scope of this invention, will be readily apparent to those of ordinary skill in the art based upon this disclosure, e.g., the exemplary flowcharts or processes described herein may be modified and varied and yet still be in the spirit of the invention. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A method of playing a card game by a dealer and a player, the game comprising:
accepting the player's first wager;
dealing two cards to the player to comprise a player's hand;
dealing two cards to the dealer to comprise a dealer's hand;
accepting the player's second wager indicating the player's hand will be resolved against the dealer's hand under five-card poker rules after three or more community cards are dealt face-up, wherein the first wager and second wager comprise the player's total wager;
dealing three or more community cards face-up;
dealing zero or more cards to the dealer's hand according to Blackjack counting rules for filling the dealer's hand;
configuring a first highest ranking five-card hand from a combination of the dealer's hand and the dealt community cards;
configuring a second highest ranking five-card hand from a combination of the player's hand and the dealt community cards; and
if the configured player's hand ranks higher than the configured dealer's hand based on five-card poker rules, then paying the player based on the player's total wager.

2. The method of playing a card game of claim 1 wherein the step of dealing two cards to the dealer comprises dealing one card face-up and one card face-down to the dealer.

3. A method of playing a card game of claim 1 further comprising, after the step of accepting the player's second wager, the step of turning the card dealt face-down of the dealer's hand face-up.

4. A machine-enabled method of playing a card game comprising three or more community cards having states, a plurality of cards comprising a card hand of a player wherein each card of the card hand of the player has a state, and a plurality of cards comprising a card hand of a house or dealer wherein each card of the card hand of the house has a state, the machine-enabled game comprising:
providing a machine configured to receive player input via a user interface and output, via the user interface: the state of each house's card, the state of each player's card, the state of the three or more community cards, and a play resolution result;
accepting, as a machine input via the user interface, a player's first wager;
generating a state for each of two player cards;
outputting, as a machine output via the user interface, the state of the two generated player cards;
generating a state for each of a first house card and a second house card;
outputting, as a machine output via the user interface, the state of the first generated house card;
accepting, as a machine input via the user interface, the player's second wager, wherein the first wager and second wager comprise the player's total wager;
generating a state for each of three or more community cards;
outputting, as a machine output via the user interface, the states of each of the three or more generated community cards;
outputting, as a machine output via the user interface, the state of the second generated house card; and
filling, according to Blackjack counting rules for filling the house's hand, by generating a state for each of zero or more additional cards for the house's hand;
outputting, as a machine output via the user interface the states of each of the zero or more generated additional cards of the house's hand;
if the player's second wager was accepted, then resolving comprising:
configuring a first highest ranking five-card hand as the final house's hand from a combination of states of the cards of the filled house's hand and the states of the community cards;
configuring a second highest ranking five-card hand as the final player's hand from a combination of states of the cards of the player's hand and the states of the community cards; and
testing if the states of the card combination of the final player's hand rank higher based on five-card poker rules than the states of the card combination of the final house's hand, and then generating a payout based on the player's total wager, and outputting, via the user interface, the play resolution result comprising the payout.

5. A gaming device for playing a card game comprising;
a central processing unit (CPU) in communication with accessible memory and a user
interface via a data bus wherein the CPU is configured to execute the steps of:
accepting a player's first wager;
generating a state for each of two player cards;
outputting the state of the two generated player cards;
generating a state for each of a first house card and a second house card;
outputting the state of the first generated house card;
accepting the player's second wager, wherein the first wager and second wager comprise the player's total wager;
generating a state for each of three or more community cards;
outputting the states of each of the three or more generated community cards;
outputting the state of the second generated house card; and
filling, according to Blackjack counting rules for filling the house's hand, by generating a state for each of zero or more additional cards for the house's hand;
outputting the states of each of the zero or more generated additional cards of the house's hand;
if the player's second wager was accepted, then resolving comprising:
configuring a first highest ranking five-card hand as the final house's hand from a combination of states of the cards of the filled house's hand and the states of the community cards;
configuring a second highest ranking five-card hand as the final player's hand from a combination of states of the cards of the player's hand and the states of the community cards; and
testing if the card state combination of the final player's hand ranks higher based on five-card poker rules than the cards state combination of the final house's hand, and then generating a payout based on the player's total wager and outputting a play resolution result comprising the payout.
